(19) United States
(12) Patent Application Publication
(10) Pub. No.: US 2012/0254582 A1
(43) Pub. Date: Oct. 4, 2012

(54) TECHNIQUES AND MECHANISMS FOR LIVE MIGRATION OF PAGES PINNED FOR DMA

(76) Inventors: ASHOK RAJ, Portland, OR (US); RAJESH M. SANKARAN, Portland, OR (US)

(21) Appl. No.: 13/076,731

(22) Filed: Mar. 31, 2011

(51) Int. Cl. G06F 12/10

(52) U.S. Cl. 711/206; 711/E12.061

(57) ABSTRACT

Techniques for migrating data from a first range of physical memory locations to a second range of physical memory locations. The second range of physical memory locations is allocated for migration of data from the first range of physical memory locations Pending transactions for the first range of physical memory locations are flushed. One or more address translation entries are reprogrammed. Data is migrated from the first range of physical memory locations to the second range of physical memory locations. Subsequent memory transactions are processed to cause the transactions to be directed to the second range of physical memory locations.

### TECHNICAL FIELD

Embodiments of the invention relate to memory management techniques. More particularly, embodiments of the invention relate to techniques for managing direct memory access (DMA) traffic to individual memory modules.

### BACKGROUND

Servers in mission critical environments are generally required to provide high reliability, serviceability and availability characteristics. Memory modules, for example, dual inline memory modules (DIMMs) are components that are frequently subject to failures and can cause catastrophic memory system failures. Most modern operating systems employ techniques to prevent such failures by monitoring soft error rates in memory module components and thereby not using modules that has a high probability of failing. This technique may be referred to as Predictive Failure Analysis (PFA). For example, if the number of detected errors exceeds a threshold amount, replacement may be recommended. In these systems, memory module replacement requires downtime.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a conceptual diagram of one embodiment of a system that may receive data to be transferred to memory via direct memory access (DMA) mechanisms that support migration of data as described herein.

FIG. 2 is a flow diagram of one embodiment a technique for relocating data from one set of physical memory addresses to a second set of physical memory addresses involving DMA mechanisms.

FIG. 3 is a block diagram of one embodiment of an electronic system that may provide migration of data as described herein.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Operating systems have the ability to migrate user pages that are available to the operating system. However, physical memory pinned for direct memory access (DMA) use cannot be easily migrated by the operating system because this requires communication with the device before the relevant physical memory areas can be retired from use. Described herein are techniques that allow migration of data stored in physical memory pinned for DMA use. In one embodiment an input/output memory management unit (IOMMIU) may be utilized along with operating system (OS) and/or virtual machine manager (VMM) support to provide migration of data stored in physical memory locations pinned for DMA use.

Current technologies do not support migration of DMA pages. Most operating systems that allow memory removal co-locate DMA pages in a single node, and the expectation is that this memory has sufficient redundancy so as to be more resilient. Forcing all memory to a single node increases the path to memory and increases the latency including bandwidth issues due to NUMA characteristics.

The techniques described herein may be utilized, for example, to relocate a physical page from a faulty DIMM to another DIMM. IOMMU page tables may be reprogrammed or modified so that subsequent DMA translations utilize the new page. This may permit removal of the old page from faulty (or otherwise undesirable) physical memory.

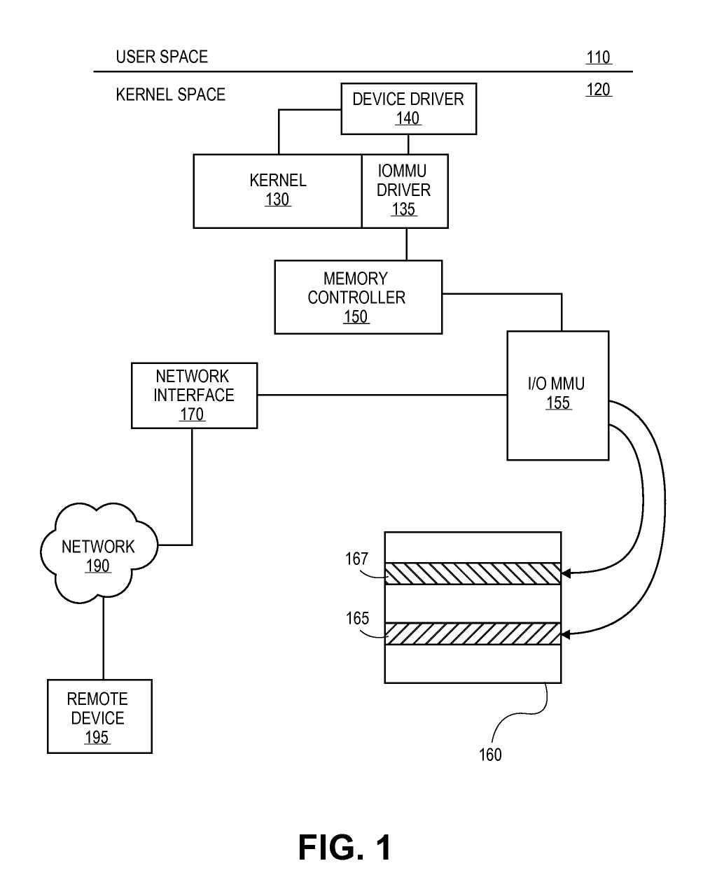

FIG. 1 is a conceptual diagram of one embodiment of a system that may receive data to be transferred to memory via direct memory access (DMA) mechanisms that support migration of data as described herein. The system of FIG. 1 may be any type of electronic system. Further details of an electronic system are provided below.

A host electronic system may be conceptually divided into at least user space 110 and kernel space 120. User space 110 may refer to resources, for example, memory locations that are used for applications and other user oriented operations. Kernel space 120 may refer to resources that are used for operating system and other system functionality purposes.

Kernel 130 resides in kernel space 120. Kernel 130 is the central component of the operating system running on the electronic system of FIG. 1. In one embodiment, I/O Memory Management Unit (IOMMU) driver 135 interfaces with kernel 130 to provide memory management functionality to the host system. In one embodiment, device driver 140 interfaces with kernel 130 and/or IOMMU driver 135 to provide low level system services to one or more applications. Only one device driver is illustrated in FIG. 1 for reasons of simplicity only, any number of device drivers may be supported. Device driver 140 may utilize DMA mechanisms to access memory locations.

When the system is operating, remote device 195 may send a request that results in a memory access via DMA mechanisms. Remote device 195 may communicate with the system via network 190. Network interface 170 provides an interface to network 190 for the host system. Network interface 170 may be any type of network interface known in the art.

Messages from remote device are received by network interface 170. The messages are passed from network interface 170 to IOMMU 155 after translation of the I/O virtual address received from network interface 170. Memory controller 150 provides an interface to IOMMU 155, which may be maintained as a table or other suitable structure. IOMMU 155 provide a mapping to physical addresses included in memory system 160.

Memory controller 150 interfaces with IOMMU driver 135 to manage memory accesses including DMA memory accesses. IOMMU driver 135 and or device driver 140 may function as described below to manage and control at least mapping of virtual addresses to physical addresses for the DMA mechanism. IOMMU driver 135 and device driver 140 may provide additional functionality as well.

IOMMU driver 135 and memory controller 150 operate to manage memory accesses using IOMMU 155. IOMMU 155 provides mapping to multiple physical memory locations in physical memory system 160. Physical memory system 160 may include multiple physical memory devices (e.g., multiple DIMMs). For example, memory locations 165 maybe be located on a different physical memory device than memory locations 167.

During operation, IOMMU driver 135 and memory controller 150 may function as described herein to migrate data from, for example, memory locations 165 to memory locations 167. In one embodiment, memory controller 150 or other system component is coupled with physical memory system 160 to monitor errors and other statistical information related to performance of physical memory system 160. This information may be utilized to determine when data should be migrated between physical memory devices. In one embodiment, the PFA statistical data could be compiled by an operating system agent, or may be performed in a system BIOS/BMC, etc.

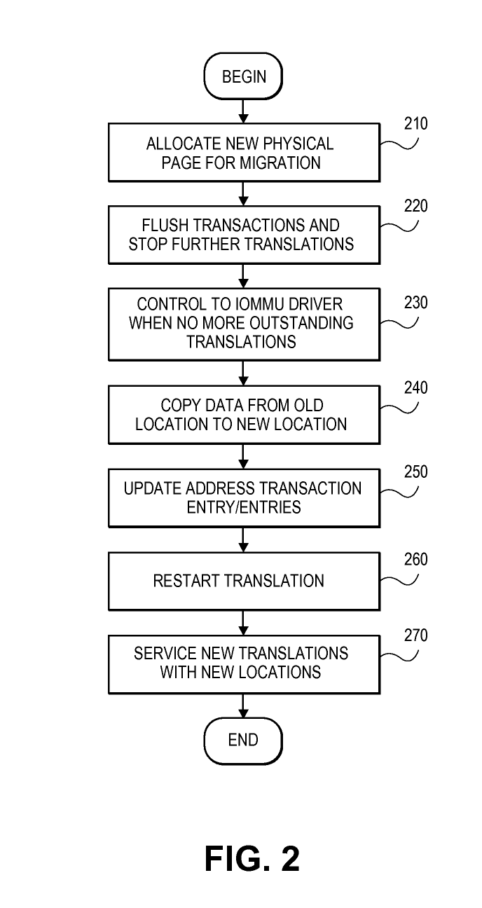

FIG. 2 is a flow diagram of one embodiment a technique for relocating data from one set of physical memory addresses to a second set of physical memory addresses involving DMA mechanisms. The example provided with respect to FIG. 2 is related to moving pages from a DIMM generating excessive corrected errors to another DIMM. However, the techniques described with respect to FIG. 2 may be utilized for other applications.

The techniques described with respect to FIG. 2 may be performed for each page of a physical memory module until all data in the physical memory module has been migrated. The operating system, or other system entity, can indicate that the memory module may be safely replaced. If the IOMMU uses large pages, copying a large page may have latency implications to hold the DMA during the page copy. In one embodiment, the IOMMU driver performing the page relocation could choose to break the large page into multiple smaller (e.g., 4 kbyte, 16 kbyte, 32 kbyte) chunks before doing the page migration and then re-assemble back to a large page.

In one embodiment, an IOMMU driver, or other system component, may allocate a new physical page for migration, 210. In one embodiment, the new page is physically located on a different physical memory device than the page from which the data is migrated. The migration may be, for example, triggered by an operating system or other entity that detects memory failures above a pre-selected threshold. As another example, an operating system or other entity may trigger migration so that a defective memory module may be swapped for a good memory module.

A queued invalidate may be submitted to a transaction queue to flush outstanding transactions and stop further transactions, 220. In one embodiment, the invalidate and flush command are performed for specific memory regions. The invalidation and flushing allows the pending transactions/translations to be processed using the old physical memory before the transition to the new physical memory location. This prevents loss and/or corruption of data.

Control is transferred to the IOMMU driver when the pending queue has been flushed, 230. At this point there are no pending transactions for the DMA and incoming transactions have been stopped and stored until the transactions can be restarted.

The IOMMU driver copies data stored in the old physical memory locations to the new physical memory locations, 240. The new physical memory locations may be on a single physical memory module, or may be distributed across multiple physical memory modules.

The IOMMU driver, or other system entity, reprograms one or more translation structures, 250. In one embodiment, the highest level of the translation tables is reprogrammed to indicate the new physical address to be used. In one embodiment, the IOMMU driver updates the Page Table Entry (PTE) entries corresponding to the new page. In a multi-level table structure, only the last level may have to be updated.

The page size to be used may be determined, at least in part, on the amount of time that is required to transfer data between pages. The smaller the page, the less time is required, which results in lower memory latencies when a migration occurs. In one embodiment, pages may be segmented into smaller fragments, for example, 4 kbytes. Other fragment and/or page sizes can also be supported.

The IOMMU driver may submit a command to restart translation, 260. At this point, new DMA requests or translations are serviced by the new physical memory locations, 270. The old physical memory locations may be retired from use. In one embodiment, in the case of a device using Address Translation Services (ATS), the IOMMU driver may invalidate any translations before proceeding with the steps above. Otherwise, the target device may have state translations that would not be aware of the new physical page.

Some IOMMU implementations have the ability to hold translations for a given page under certain conditions, for example, if an existing translation results in a miss that causes a page walk, subsequent translations to the same page are blocked until the pending page walk is completed. Similarly, when, for example, an IOTLB for a page is invalidated, the techniques described herein may guarantee that any translated requests are completed before the invalidate command is completed.

The IOMMU capability that provides the capability to hold off new request that can be used to support the techniques described herein. Specifically, when the operating system submits an invalidate command; it can also specify a flag to suspend instead of resume immediately. Later, when the operating system, or other system entity, has performed the page copy, it can submit another invalidate command with a resume flag to permit translations to continue.

In one embodiment, the techniques described herein may enable a short quiesce and resume flow for IOTLB invalidation that can be used in memory over commit scenarios when used with driver assist. In one embodiment, the IOMMU driver can set up page tables without setting the PTE, but by clearing the permissions when doing a memory over commit. When doing a copy on write, reads may be allowed, but writes may be blocked by clearing permissions appropriately in leaf PTE entries.

In one embodiment, when a DMA wrote to an IO virtual address is attempted, the IOMMU driver may intercept the fault, perform a page pin or set up PTE and submit a resume command. If page relocation is require, the copy could be performed before the leaf PTE permissions are updated and the resume command is submitted.

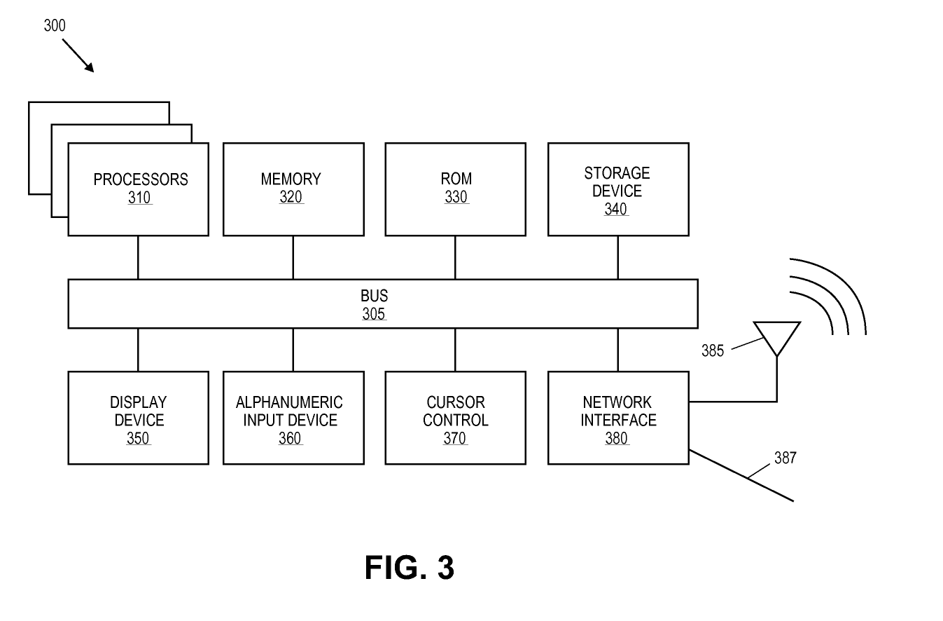

FIG. 3 is a block diagram of one embodiment of an electronic system that may provide migration of data as described herein. The electronic system illustrated in FIG. 3 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

In one embodiment, electronic system 300 is a tablet device or a smartphone device. These devices may have multiple wireless interfaces, for example, WiFi and/or cellular, or other combinations of wireless interfaces. Further, these devices may have a touch screen interface or other type of user interface that allows a user to interact with the device without the need of external components such as keyboards, mice, pointers, etc.

Electronic system 300 includes bus 305 or other communication device to communicate information, and processor 310 coupled to bus 305 that may process information. While electronic system 300 is illustrated with a single processor, electronic system 300 may include multiple processors and/or co-processors. Electronic system 300 further may include random access memory (RAM) or other dynamic storage device 320 (referred to as main memory), coupled to bus 305 and may store information and instructions that may be executed by processor 310. Main memory 320 may also be used to store temporary variables or other intermediate information during execution of instructions by processor 310.

Electronic system 300 may also include read only memory (ROM) and/or other static storage device 330 coupled to bus 305 that may store static information and instructions for processor 310. Data storage device 340 may be coupled to bus 305 to store information and instructions. Data storage device 340 such as a magnetic disk or optical disc and corresponding drive may be coupled to electronic system 300.

Electronic system 300 may also be coupled via bus 305 to display device 350, such as a cathode ray tube (CRT) or liquid crystal display (LCD), to display information to a user. Alphanumeric input device 360, including alphanumeric and other keys, may be coupled to bus 305 to communicate information and command selections to processor 310. Another type of user input device is cursor control 370, such as a mouse, a trackball, or cursor direction keys to communicate direction information and command selections to processor 310 and to control cursor movement on display 350.

Electronic system 300 further may include network interface(s) 380 to provide access to a network, such as a local area network. Network interface(s) 380 may include, for example, a wireless network interface having antenna 385, which may represent one or more antenna(e). Network interface(s) 380 may also include, for example, a wired network interface to communicate with remote devices via network cable 387, which may be, for example, an Ethernet cable, a coaxial cable, a fiber optic cable, a serial cable, or a parallel cable.

In one embodiment, network interface(s) 380 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

In addition to, or instead of, communication via wireless LAN standards, network interface(s) 380 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method for migrating data from a first range of physical memory locations to a second range of physical memory locations comprising:
allocating the second range of physical memory locations for migration of data from the first range of physical memory locations;
flushing pending transactions for the first range of physical memory locations;
reprogramming one or more address translation entries;
migrating data from the first range of physical memory locations to the second range of physical memory locations; and
processing subsequent memory transactions to cause the transactions to be directed to the second range of physical memory locations.

2. The method of claim 1 wherein the first range of physical memory locations are located on a first physical memory device and the second range of physical memory locations is located on a second physical memory device.

3. The method of claim 1 further comprising:
monitoring one or more error rates for at least the first range of physical memory locations; and
initiating migration of the data in response to at least one of the one or more error rates meeting or exceeding a corresponding threshold value.

4. The method of claim 1 wherein reprogramming one or more address translation entries comprises reprogramming a last level entry in a multi-level translation structure.

5. The method of claim 1 wherein memory accesses to the first range of physical memory locations are provided via a direct memory access (DMA) mechanism.

6. The method of claim 5 wherein memory accesses to the second range of physical memory locations are provided via the direct memory access (DMA) mechanism.

7. A system comprising:
a physical memory system to store data;
a memory controller coupled with the physical memory system, the memory controller having access to one or more structures storing information of mapping between virtual addresses and physical addresses, the physical memory system including at least a first range of physical memory locations and a second range of physical memory locations;
an input/output memory management unit (IOMMU) coupled with the memory controller, the IOMMU to cause to be allocated, the second range of physical memory locations for migration of data from the first range of physical memory locations, to cause flushing pending transactions for the first range of physical memory locations, to cause reprogramming one or more address translation entries to cause migration of data from the first range of physical memory locations to the second range of physical memory locations, and to cause processing of subsequent memory transactions to cause the transactions to be directed to the second range of physical memory locations.

8. The system of claim 7 wherein the first range of physical memory locations are located on a first physical memory device and the second range of physical memory locations is located on a second physical memory device.

9. The system of claim 7, wherein the IOMMU further causes monitoring of one or more error rates for at least the first range of physical memory locations, and initiating of migration of the data in response to at least one of the one or more error rates meeting or exceeding a corresponding threshold value.

10. The system of claim 7 wherein reprogramming one or more address translation entries comprises reprogramming a last level entry in a multi-level translation structure.

11. The method of claim 7 wherein memory accesses to the first range of physical memory locations are provided via a direct memory access (DMA) mechanism.

12. The method of claim 11 wherein memory accesses to the second range of physical memory locations are provided via the direct memory access (DMA) mechanism.

13. An apparatus for migrating data from a first range of physical memory locations to a second range of physical memory locations comprising:
means for allocating the second range of physical memory locations for migration of data from the first range of physical memory locations;
means for flushing pending transactions for the first range of physical memory locations;
means for reprogramming one or more address translation entries;
means for migrating data from the first range of physical memory locations to the second range of physical memory locations; and
means for processing subsequent memory transactions to cause the transactions to be directed to the second range of physical memory locations.

14. The apparatus of claim 13 wherein the first range of physical memory locations are located on a first physical memory device and the second range of physical memory locations is located on a second physical memory device.

15. The apparatus of claim 13 further comprising:
means for monitoring one or more error rates for at least the first range of physical memory locations; and
means for initiating migration of the data in response to at least one of the one or more error rates meeting or exceeding a corresponding threshold value.
